(19) United States
(12) Patent Application Publication
(10) Pub. No.: US 2004/0197596 A1
(43) Pub. Date: Oct. 7, 2004

(54) Spacerless parallel passage contractor

(75) Inventors: Denis J. Connor, West Vancouver (CA); David G. Doman, Surrey (CA)

Correspondence Address: KLARQUIST SPARKMAN, LLP, 121 SW SALMON STREET, SUITE 1600, PORTLAND, OR, 97204, US

(73) Assignee: QuestAir Technologies Inc.

(21) Appl. No.: 10/771,980

(22) Filed: Feb. 3, 2004

Related U.S. Application Data
(60) Provisional application No. 60/444,733, filed on Feb. 3, 2003.

(51) Int. Cl. C03C 27/02

(52) U.S. Cl. 428/630

(57) ABSTRACT

A parallel passage contactor structure which advantageously does not require a spacing member is provided according to the present invention. In an embodiment of the present invention a parallel passage contactor is provided comprising multiple layers of sheet material wherein the sheet material is perforated with a regular pattern of openings. The perforated openings in the sheet material comprising the layers of the contactor structure are arranged such that when multiple similarly perforated layers of material are suitably layered in contact with each other the perforated openings in adjacent layers form substantially continuous parallel passages suitable for the conduction of fluids.

### CROSS REFERENCE TO RELATED APPLICATION

This application claims priority to U.S. provisional application No. 60/444,733 filed Feb. 3, 2003, which is incorporated herein by reference.

### FIELD

The present disclosure relates to parallel passage contactors, and more particularly to parallel passage contactors assembled from multiple layered sheet elements which allow for fluid flow therethrough.

### BACKGROUND

Parallel passage contactors incorporating layered sheet structures have been disclosed in the prior art, and have been developed to facilitate efficient contact of a fluid with the surfaces of the passages inside the contactor. Some applications of the parallel passage contactors of the prior art include heat exchange radiators, catalyst support structures and pressure swing adsorption adsorber elements. An example of parallel passage contactor design in the prior art adapted for application in pressure swing adsorption adsorber elements is disclosed in co-pending U.S. patent application Ser. No. 09/839,381 to Keefer et al. The construction of the passages in the parallel passage contactors disclosed in the prior art includes multiple layers of thin sheet material arranged in a stacked or rolled configuration to form the functional fluid-contact portion of the contactor structure. In both the stacked and rolled configurations disclosed in Keefer et al., spacer elements are required to space adjacent layers of the sheet material from each other to form the flow passages which allow fluid flow through the contactor. In order to provide uniform fluid flow through the contactor and uniform fluid contact with the sheet material within the contactor, the spacer elements utilized in the contactor structures of the prior art are required to be precise in dimension and location between the adjacent layers of sheet material. The production and assembly of such precision spacer elements in the contactor structures of the prior art adds expense and complexity to the contactor structure above that of solely producing the layered sheet material which forms the functional contact surfaces for fluid flow interaction within the contactor structure.

### SUMMARY

The inventive spacerless parallel passage contactor of the present disclosure attempts to address some of the shortcomings of the parallel passage contactor apparatus of the prior art.

In a first embodiment of the present disclosure a parallel passage contactor is provided comprising multiple layers of thin sheet material wherein the sheet material is perforated with a regular pattern of openings. The perforated openings in the sheet material comprising the layers of the contactor structure are arranged in a regular pattern such that when multiple similarly perforated layers of material are layered in substantially coplanar contact with each other so that the openings in alternating layers are substantially identically aligned with each other, the openings in adjacent layers overlap to form substantially continuous passages along the plane of contact wherein the passages alternate between adjacent layers of the perforated material according to the location of the openings in the adjacent layers. In each of the co-operating adjacent layers, the passage is defined by the perforated opening in a given layer, and is contained by the non-perforated portions of the layer above and below that given layer. The multiple layers of sheet material may be stacked vertically on top of each other, or may be wound in multiple spirally concentric layers, or otherwise arranged to form a substantially unitary structure of layered material which comprises the body of the parallel passage contactor. The patterned perforation of the thin sheet material making up the present parallel passage contactor may be precisely controlled at a large range of scales from relatively large to very small openings according to known means and methods which exist in the art for perforating most available types of thin sheet materials, resulting in precise control of the lateral dimensions of the passages (relative to the plane of the sheet material) in the present parallel passage contactor. Further, as the height of the parallel passages is equal to the thickness of the sheet material used, and not reliant on the placement and uniformity of an additional spacing means, the thickness of the passages in the present contactor may be very precisely controlled. In such a way, a parallel passage contactor with a high density of precisely uniform parallel fluid flow passages may be constructed from multiple layers of perforated sheet material, providing for contact of a fluid flowing through the passages with the surfaces of the thin sheet materials making up the contactor, without the need for, or added expense and complexity of additional spacing means to define the flow channels.

The parallel passage contactor structure described above in a first embodiment of the present disclosure may be adapted for use in a wide variety of applications requiring surface contact with a fluid stream, including, but not limited to, parallel passage adsorbers for adsorptive processes such as pressure swing or temperature swing adsorption, catalyst support structures for catalytic reaction elements, or heat exchange cores for surface contact with heating and coolant fluids. In the case of a parallel passage adsorber for adsorptive processes, laminated adsorbent sheets may be used as sheet material in the parallel passage contactor structure of the above described first embodiment. Satisfactory laminated adsorbent sheets have been produced by coating a slurry containing adsorbent material onto a support substrate such as a metallic foil, wire mesh or composite scrim as is disclosed in co-pending U.S. patent application Ser. No. 10/041,536, the contents of which are herein incorporated by reference. Such laminated adsorbent sheets may be perforated as described above, and connected in aligned coplanar contact potentially by using any suitable bonding agent, or by containment pressure from an external enclosure, to form a parallel passage adsorber. A parallel passage adsorber composed of perforated laminated adsorbent sheets according the above first embodiment of the present disclosure provides advantageous control of fluid flow passage dimensions, and potentially lower manufacturing cost, higher stiffness and higher strength of the adsorber block relative to an adsorber composed of similar laminated sheets but using additional spacing means to define the flow passages.

In a second embodiment of the present disclosure, a parallel passage contactor comprised of multiple layers of perforated thin sheet material, aligned as described above in a first embodiment to form multiple parallel flow passages, is provided, wherein the sheet material is a laminated adsorbent sheet containing an adsorbent material suited for pressure swing adsorption, such as molecular sieve (such as zeolite or titania based materials), carbon adsorbents, alumina or silica materials, and the contactor is adapted for use as a parallel passage adsorber module within a pressure swing adsorption system, wherein said pressure swing adorption system may incorporate a rotary valve means for controlling gas flows between the adsorber module(s) in the pressure swing adsorption system.

In a third embodiment of the present disclosure, a parallel passage contactor is provided wherein the contactor is comprised of multiple layers of identically perforated thin sheet material stacked vertically on top of each other, wherein the perforations are oriented in a regular pattern. The multiple thin sheets are stacked vertically in precise alignment with each other such that the aligned identical perforations form parallel vertical passages extending through the multiple layers of the contactor, without the need for additional spacer means between the layers of sheet material, said parallel passages suitable for allowing fluid flow therethrough. A spacerless parallel passage contactor produced according to the present third embodiment of the disclosure may be adapted for use in a wide variety of applications requiring surface contact with a fluid stream, including, but not limited to, parallel passage adsorbers for adsorptive processes such as pressure swing or temperature swing adsorption, catalyst support structures for catalytic reaction elements, or heat exchange cores for surface contact with heating and coolant fluids. The thin sheets of material used to construct the contactor body may be made of any material suited to the intended use of the contactor, including but not limited to metal, ceramic or laminated adsorbent sheet material. The multiple sheets may be held in contact with each other by any suitable bonding or attachment means, or alternatively by containment pressure between a pair of end plates which may be identically perforated and aligned with the thin sheets, to form ends of the contactor, such end plates allowing fluid flow to pass through both the entire contactor structure in the parallel passages, from one outer end plate surface to the opposite end plate surface.

The multiple thin sheets comprising the contactor may be perforated by any suitable known means which may be compatible with the type of sheet material used, and provide adequate precision to allow exact alignment of the sheets, such as laser drilling or chemical machining or other known means. The thin sheets may be coated with chemically or catalytically active substances, such as adsorbents, or catalyst materials, particularly for uses of the contactor structure in applications such as adsorbers for adsorptive processes or catalytic reactors. In such cases, the chemically or catalytically active substances may be coated onto or impregnated in the thin sheets using any suitable known coating technique, including wash coating, impregnation coating, electrophoretic deposition or other methods.

In a fourth embodiment of the present disclosure, a parallel passage contactor comprised of multiple layers of perforated thin sheet material, perforated by chemical machining means, precisely aligned in a vertical column as described above in a third embodiment to form multiple vertical parallel flow passages, is provided, wherein the sheet material is a thin metal sheet or foil, coated by means such as electrophoretic deposition with an adsorbent material suited for pressure swing adsorption, such as zeolite, alumina or silica materials, and the contactor is adapted for use as a parallel passage adsorber module within a pressure swing adsorption system. In the present fourth embodiment, the pressure swing adorption system may optionally incorporate a rotary valve means for controlling gas flows between the adsorber module(s) in the pressure swing adsorption system. The size and orientation of the perforations in the thin metal sheets or foils may be precisely controlled by the chemical machining process, to produce an optimal areal density of perforations to facilitate adsorption within the parallel flow channels. The thickness of the adsorbent material coated onto the thin metal sheets or foils in the present embodiment may be precisely controlled by the electrophoretic deposition or other suitable process to provide a suitable thickness for allowing effective adsorption within the parallel passage adsorber, while preventing blockage of the chemically machined perforations. Uncoated end plates perforated identically to the thin sheets or foils, and made of a thicker and stronger material may be provided to enclose the adsorber structure to provide advantageous strength and durable outer contact surfaces for communication with valving means in a pressure swing adsorption system. Optionally the diameter of the perforations in the thin metal sheets or foils may be tapered toward a second product end of the adsorber structure, relative to a first feed end of the structure, in order to reduce dead volume in the product end of the adsorber, and contribute to increased efficiency of operation of the adsorber in a pressure swing adsorption system.

### BRIEF DESCRIPTION OF THE DRAWINGS

FIG. 1 shows a plan view of a first thin sheet perforation pattern for use in a spacerless parallel passage contactor according to an embodiment of the present disclosure.

FIG. 2 shows a plan view of a second complimentary thin sheet perforation pattern for use in a spacerless parallel passage contactor according to an embodiment of the present disclosure.

FIG. 3 shows a plan view of two adjacent and corresponding thin sheets perforated according to the perforation patterns shown in FIGS. 1 and 2 respectively, for use in a spacerless parallel passage contactor according to an embodiment of the present disclosure.

### DETAILED DESCRIPTION OF AN EMBODIMENT

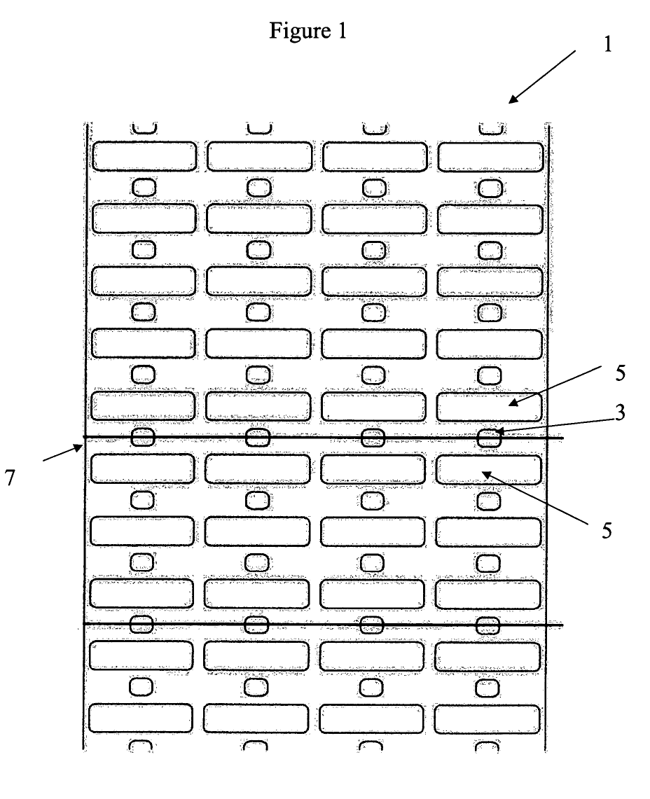

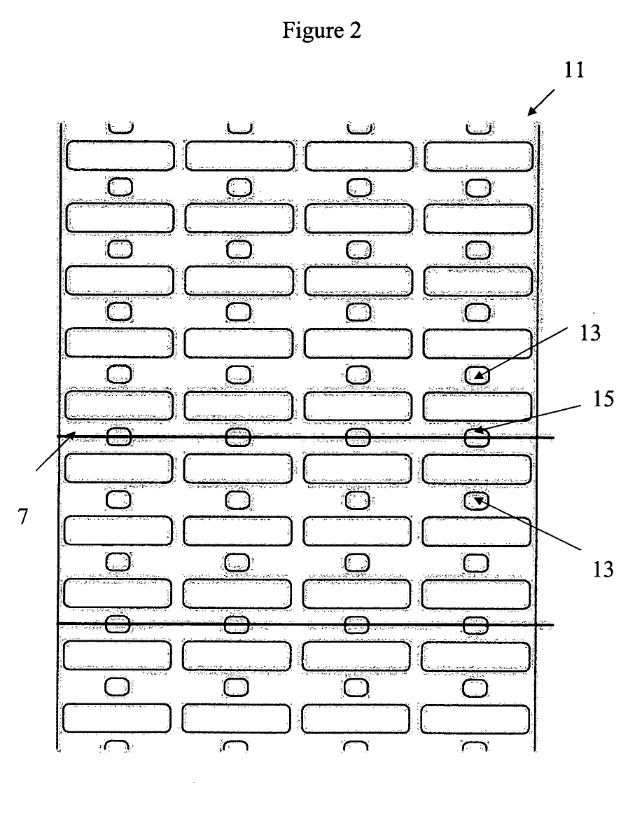

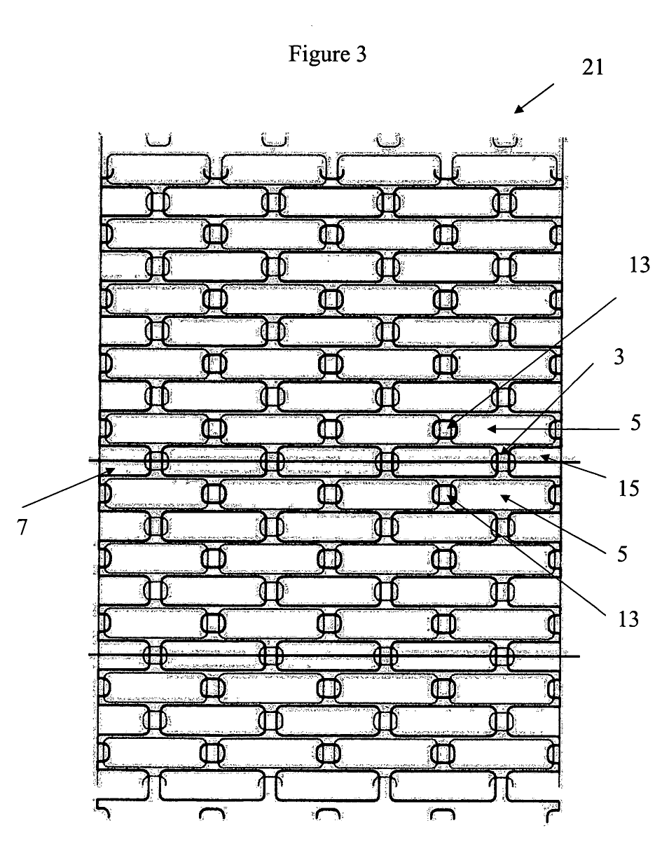

In a particular embodiment of the present invention as shown in FIG. 1, a first thin sheet 1 having a regular pattern of perforations suitable for use in a spacerless parallel passage contactor according to the present invention is provided. The regular perforation pattern of thin sheet 1 includes a first set of repeating connecting openings 3 and a second set of repeating passage openings 5. As can be seen in FIG. 1, in thin sheet 1, it is the connecting openings 3 that are aligned along reference line 7, which is indicated only to show alignment of openings. A second thin sheet 11 having a regular pattern of perforations similar to those of first sheet 1 suitable for use in cooperation with first sheet 1 for forming a spacerless parallel passage contactor is provided. Second thin sheet 11 also includes a set of repeating connecting openings 13 and a second set of repeating passage openings 15. As shown in FIG. 2, it is the passage openings 15 that are aligned along reference line 7. Thin sheets similar to first sheet 1 and second sheet 11 are shown in adjacent overlapping alignment as parallel passage contactor segment 21 according to the present invention in FIG. 3. As can be seen along reference line 7, the perforated passage openings 15 of the second of the cooperating adjacent sheets are aligned such that they are overlapped and connected by the connecting openings 3 of the first of the cooperating adjacent sheets. Similarly as shown in alternating rows of openings immediately above and below reference line 7, the passage openings of 5 of the first cooperating adjacent sheet, are aligned such that they are overlapped and connected by the connecting openings 13 of the second cooperating adjacent sheet. In such a manner, multiple perforated sheets may be stacked or otherwise suitably vertically aligned to produce the connecting parallel passages of the parallel passage contactor segment 21 according to the present invention. The shape, relative dimensions and spacing of passage openings 5, 15, and connecting openings 3, 13 may be varied as desired in the inventive parallel passage contactor such that they form the desired parallel flow passages required for use of the contactor for a specific application such as an adsorbent bed, a catalytic reactor bed, or a heat exchanger core. Similarly, the thickness of the sheets 1, 11 used to form the contactor may be varied as desired to produce flow passages of dimensions suitable for specific applications such as those described above. The sheets 1, 11 may also be made of any suitable material for the desired application of the contactor, and may be coated, impregnated, or otherwise treated with additional suitable materials such as active compounds (potentially including adsorbent materials, catalytically active substances, surface enhancers, etc.), as described earlier in this disclosure. Further, the parallel passage contactor according to the present invention may optionally be enclosed in an external enclosure or vessel such as may be suitable for a desired application of the contactor. For example, in the case of the use of the parallel passage contactor of the present invention as an adsorbent bed for pressure swing adsorption, the contactor may be enclosed in a pressure vessel suitable to contain the pressure variations of the desired pressure swing adsorption cycle.

Having described the principles of the disclosure with reference to several embodiments, it will be apparent to those of ordinary skill in the art that the invention may be modified in arrangement and detail without departing from such principles.

We claim:

1. A spacerless parallel passage contactor comprising multiple adjacent layers of sheet material, said sheet material comprising perforated openings arranged in a regular pattern and aligned such that the openings in adjacent layers of sheet material overlap to form connected substantially continuous flow passages.

2. The spacerless parallel passage contactor according to claim 1 wherein the sheet material comprises thin adsorbent sheet material comprising at least one active adsorbent material.

3. The spacerless parallel passage contactor according to claim 2 wherein the active adsorbent material is chosen from the list comprising: molecular sieves, carbon adsorbents, alumina adsorbents, and silica adsorbents.

4. The spacerless parallel passage contactor according to claim 3 wherein the contactor is adapted for use as an adsorber bed in a pressure swing adsorption process.

5. The spacerless parallel passage contactor according to claim 3 wherein the contactor is adapted for use as an adsorber bed in a temperature swing adsorption process.

6. The spacerless parallel passage contactor according to claim 1 wherein the sheet material comprises thin catalyst support sheet material comprising at least one active catalyst material.

7. The spacerless parallel passage contactor according to claim 6 wherein the contactor is adapted for use as a catalyst bed in a catalytic reaction process.

8. The spacerless parallel passage contactor according to claim 1 wherein the sheet material comprises thin heat conductive sheet material.

9. The spacerless parallel passage contactor according to claim 9 wherein the thin heat conductive sheet material comprises metallic foil.

10. The spacerless parallel passage contactor according to claim 8 wherein the contactor is adapted for use as a heat exchange core for transferring heat to or from at least one fluid flowing within the flow passages of the contactor.
